(19) United States
(12) Patent Application Publication
(10) Pub. No.: US 2026/0264485 A1
(43) Pub. Date: Sep. 10, 2026

(54) SHADE ASSEMBLY FOR A VEHICLE

(71) Applicant: DOUGLAS PLEMONS, KERENS, TX (US)

(72) Inventor: DOUGLAS PLEMONS, KERENS, TX (US)

(21) Appl. No.: 19/552,642

(22) Filed: Feb. 27, 2026

Related U.S. Application Data
(60) Provisional application No. 63/768,499, filed on Mar. 7, 2025.

(51) Int. Cl. B60J 3/00; H02S 20/30; H02S 30/20

(52) U.S. Cl. CPC B60J 3/002; H02S 20/30; H02S 30/20

(57) ABSTRACT

A shade assembly for a vehicle includes a frame assembly mounted to a roof of the vehicle with a track and a retractable shade within the track. The frame assembly includes rails and crossmembers for securing cargo across the frame assembly. The retractable shade is configured to operate within the track between an extended and a retracted position. A stop is configured to regulate movement of the retractable shade within the track such that the stop maintains the retractable shade in the track when extended. An enclosure is coupled to the frame assembly and configured to house the retractable shade. The frame assembly extends above the enclosure. A solar panel is optionally coupled to the retractable shade. Deployment of the retractable shade is configured to selectively shade the windshield of the vehicle.

### CROSS REFERENCE TO RELATED APPLICATIONS:

This application claims the benefit of an earlier filing date and right of priority to U.S. Provisional Application No. 63/768,499, filed 7 Mar. 2025, the contents of which is incorporated by reference herein in its entirety.

### BACKGROUND OF THE INVENTION

### 1. Field of the Invention

The present application relates to a vehicle shade, and more particularly to a retractable roof mounted shade assembly for a vehicle.

### 2. Description of Related Art

Excessive heat and sun exposure inside vehicles, particularly when parked outdoors, can lead to significantly higher interior temperatures. This not only makes the vehicle uncomfortable for passengers upon entry but also poses several other issues. Prolonged exposure to high temperatures can cause damage to the vehicle's interior components, such as the dashboard, seats, and upholstery, leading to fading, cracking, and deterioration over time. Harmful UV rays can further exacerbate this damage, affecting the longevity and appearance of the interior materials. Additionally, the increased heat can strain the vehicle's air conditioning system as it works harder to cool down the interior, resulting in higher fuel consumption and reduced efficiency. Overall, these factors contribute to a less pleasant driving experience and increased maintenance costs for vehicle owners.

Conventional attempts to address this issue is to use foldable shades placed along an interior surface of the windshield. Besides being bulky and difficult to manage, such shades still leave the windshield exposed to the sun and allow it to heat up. Radiating heat energy enters the vehicle interior despite the attempt to use reflective material on the shades.

Although strides have been made, shortcomings remain. A new shade is needed to minimize the effects of sun exposure to the windshield.

### BRIEF SUMMARY OF THE INVENTION

It is an object of the present application to provide a modular shade assembly to provide selective shading for a vehicle windshield. The assembly is configured to include a slidable or retractable shade operable within a track system coupled to a frame assembly mounted to the roof of the vehicle. The frame assembly can be an existing assembly with the vehicle or can be optional within the shade assembly of the present application.

It is a further object of the present application that the shade assembly be selectively housed within an enclosure coupled to the frame assembly. Solar panels may be included to collect power for electronics and/or for the vehicle.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a vehicle with a shade profile assembly according to an embodiment of the present application.

FIG. 2 is a perspective view of the shade profile assembly of FIG. 1 in a retracted configuration.

FIG. 3 is a perspective view of the shade profile assembly of FIG. 2 in an extended configuration.

FIG. 4 is an enlarged perspective view of the shade profile assembly of FIG. 3.

FIG. 5 is an enlarged section view of a frame and shade used in the shade profile assembly of FIG. 4.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The Shade assembly is a versatile roof-mounted system designed to enhance vehicle functionality through its innovative features. Constructed from durable, weather-resistant materials, it includes a retractable shade supported by a reinforced aluminum frame and stainless-steel roller bearings for smooth operation. An internal stop device ensures secure attachment, while a protective enclosure houses the shade when not in use, preserving its condition. The system also features a crossbar luggage rack, streamlined to minimize noise and seamlessly integrated with existing vehicle rails for easy installation. Additionally, optional solar panels are securely mounted to the shade, providing eco-friendly electrical power to the vehicle.

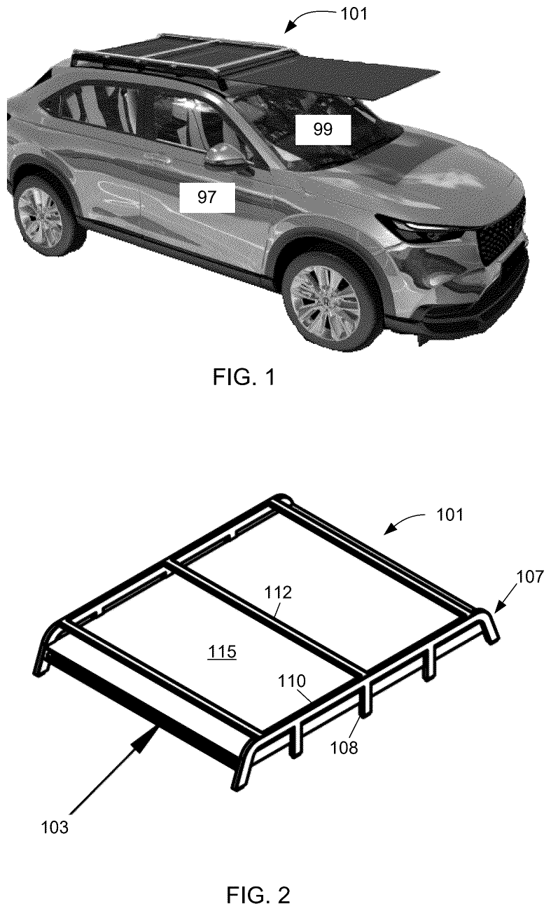

Referring now to FIGS. 1-5 in the drawings, a shade profile assembly 101 is illustrated. The shade profile assembly 101 effectively addresses the challenge of excessive heat and sun exposure within vehicles. Assembly 101 includes a retractable shade 103 configured to extend over the windshield 99 of the vehicle 97. Assembly 101 is external to vehicle 97 and is configured to shade windshield 99 to block direct sunlight from heating it. This markedly lowers interior temperatures, ensuring a more pleasant atmosphere for occupants. This also shields the dashboard and upholstery from harmful UV rays, helping to maintain the vehicle's interior quality and prolong its lifespan.

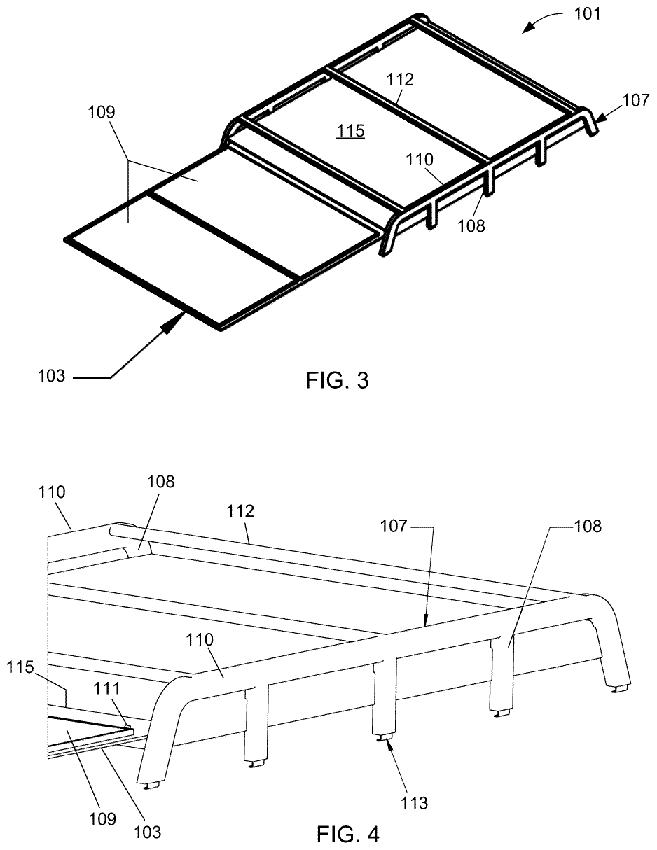

Assembly 101 includes a shade 103, a track 105, and a frame 107. Shade 103 is configured to extend and retract via track 105. Frame 107 is configured to be attached to vehicle 97 and provide support for track 105. As seen in particular with FIG. 2 in the drawings, assembly 101 is illustrated in a retracted configuration wherein shade 103 is fully retracted within 107. Alternatively, as seen in FIG. 3 of the drawings, shade 103 is illustrated in a fully extended configuration such that it extends outward and away from frame 107 in a cantilevered position. In this configuration, shade 103 is ideally suited and placed so as to overlay across windshield 97. It is understood that assembly 101 may be retrofitted into existing roof racks of vehicles such that frame 107 may be an existing vehicle roof rack. Track 105 is configured to attach to a roof rack such as frame 107.

Frame 107 is constructed using high strength weather resistant materials such as corrosion resistant reinforced aluminum frame with a corrosion resistant coating. Other materials in assembly 101 are durable and resistant to harsh environmental conditions such as sun exposure. The materials of assembly 101 are ideally suited to maintain structural integrity during various weather conditions.

Of particular note in FIG. 3 is the inclusion of solar panels 109 that are optionally included and serve to provide an alternate solution for generating extra electrical power when vehicle 97 is parked for long periods of time, such as camping. Panels 109 may be attached through known fasteners 111 that engage or couple to shade 103. It is understood that panels 109 may be removable and be wired together and integrated into existing or provided solar equipment for the purpose of capturing electrical energy. Panels 109 may be incorporated into existing wiring within vehicle 97 to allow charging of the vehicle or even just to provide operative control from the interior of vehicle 97. In an alternate configuration, assembly 101 may be routed to external equipment or other devices. Panels 109 may be secured in such a manner to allow it to safely travel when attached to shade 103 in the retracted position.

Frame 107 includes a plurality of members that are oriented in different ways and attached via known methods of construction to provide a structurally stable and rigid frame. Vertical members 108 are illustrated as extending downward from a horizontal member 110. At a distal end of member 108 is a fastener 113 configured to couple to a portion of vehicle 97. It is with fastener 113 that frame 107 is secured in place and oriented relative to vehicle 97. Fasteners 113 act as a mounting point designed to securely attach to existing rails on vehicle 97. This ensures that the entire frame 107 and corresponding assembly 101 remains firmly in place to provide consistent performance and support while on the road.

It is understood that frame 107 may include crossbar members 112 extending between side frames. These members are also made with durable weather resistant materials to allow strength and stability. It is understood that the entire frame 107 integrates seamlessly with roof mounted systems of vehicles 97. It is understood that frame 107 may be used to support luggage or other items along an upper surface while also housing shade 103 within enclosure 115 below cross members 112.

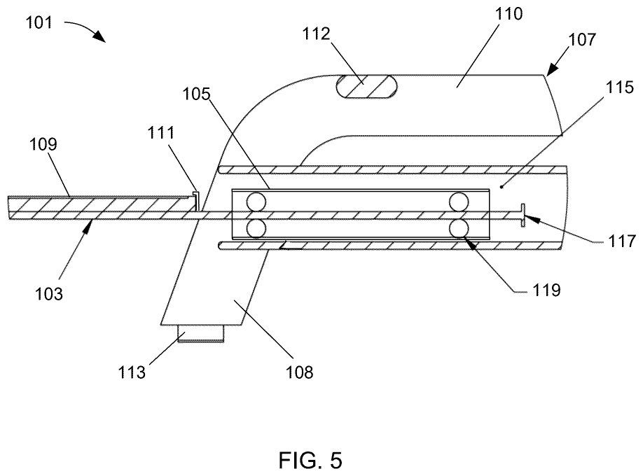

Referring now also to FIG. 5 in the drawings, an enlarged section view of assembly 101 is illustrated. Shade 103 is illustrated partially within enclosure 115 in an extended configuration. In this view, track 105 is more clearly illustrated. Assembly 101 may include one or more tracks within enclosure 115. The number of tracks 105 needed corresponds to the number necessary to allow proper function and movement of shade 103. Track 105 includes rollers 119 configured to accept shade 103 between them. Each roller in 119 is allowed to independently and freely rotate.

Shade 103 further includes a stop 117 at a distal end. Stop 117 is configured to engage tracks 105 and prevent the further extension of shade 103 outside of enclosure 115. Stop 117 prevents shade 103 from completely falling out of enclosure 115 and ensures that shade 103 remains securely attached even during full extension. When shade 103 is retracted, stop 117 functions as a latch holding the shade 103 in place within enclosure 115 during transit. It is understood that stop 117 is configured to extend outward above and below upper and lower surfaces of shade 103 and may even be magnetic or have other intrinsic properties to allow it to hold shade 103 in a retracted position.

Further illustrated in FIGS. 4 and 5 are solar panels 109, horizontal members 110, vertical member 108, cross members 112, and fasteners 113. It should be understood that enclosure 115 is configured to house shade 103 and keep it shielded from environmental conditions such as dust, rain, and UV exposure. Enclosure 115 is designed to be compact to maintain a sleek appearance and ensure that the shade is always ready for use.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A shade assembly, comprising:
a frame assembly;
a track coupled to the frame assembly; and
a retractable shade configured to operate within the track between an extended and a retracted position;
wherein the retractable shade is configured to selectively extend away from the frame to provide shade.

2. The assembly of claim 1, wherein the track includes a pair of rollers.

3. The assembly of claim 2, wherein the retractable shade passes between the pair of rollers.

4. The assembly of claim 1, further comprising:
a stop configured to regulate movement of the retractable shade such that the stop maintains the retractable shade in the track.

5. The assembly of claim 4, wherein the stop is coupled to the retractable shade.

6. The assembly of claim 4, wherein the stop is magnetic.

7. The assembly of claim 1, further comprising:
an enclosure, the retractable shade located within the enclosure.

8. The assembly of claim 1, further comprising:
solar panels.

9. The assembly of claim 8, wherein the solar panels are coupled to the retractable shade.

10. The assembly of claim 1, wherein the frame assembly is coupled to a vehicle and the retractable shade is configured to shade a windshield of the vehicle.

11. The assembly of claim 1, further comprising:
a stop configured to regulate movement of the retractable shade within the track such that the stop maintains the retractable shade in the track when extended;
an enclosure coupled to the frame assembly, the retractable shade located within the enclosure; and
a solar panel coupled to the retractable shade.

12. The assembly of claim 11, wherein the stop maintains the retractable shade in the track when retracted, the stop being magnetic.

13. A shade assembly for a vehicle, comprising:
a frame assembly coupled to the vehicle, the frame assembly including a plurality of rails and crossmembers;
a track coupled to the frame assembly;
a retractable shade configured to operate within the track between an extended and a retracted position;
a stop configured to regulate movement of the retractable shade within the track such that the stop maintains the retractable shade in the track when extended;
an enclosure coupled to the frame assembly and configured to house the retractable shade, the frame assembly extending above the enclosure; and
a solar panel coupled to the retractable shade;
wherein the retractable shade is configured to selectively extend away from the frame to provide shade.

14. The assembly of claim 13, wherein the track includes a pair of rollers.

15. The assembly of claim 14, wherein the retractable shade passes between the pair of rollers.

16. The assembly of claim 13, wherein the stop is coupled to the retractable shade.

17. The assembly of claim 13, wherein the stop is magnetic.

18. The assembly of claim 13, wherein the solar panels are coupled to the retractable shade.

19. The assembly of claim 13, wherein the retractable shade is configured to shade a windshield of the vehicle.
